(19) United States
(12) Patent Application Publication
(10) Pub. No.: US 2006/0182595 A1
(43) Pub. Date: Aug. 17, 2006

(54) Robot wrist comprising a drive unit incorporated in a tilt

(75) Inventors: Christer Lundstrom, Enkoping (SE); Rafael Nissfolk, Vasteras (SE)

Correspondence Address: VENABLE LLP, P.O. BOX 34385, WASHINGTON, DC, 20045-9998, US

(73) Assignee: ABB AB, Vasteras (SE)

(21) Appl. No.: 10/524,103

(22) PCT Filed: Aug. 19, 2003
(86) PCT No.: PCT/SE03/01291

§ 371 Date: Feb. 10, 2005

(30) Foreign Application Priority Data
Aug. 19, 2002 (SE) 0202445-3

(51) Int. Cl. B66F 9/16

(52) U.S. Cl. 414/695.8

(57) ABSTRACT

A robot wrist for an industrial robot. A wrist housing and a wrist part, designated a tilt, are journalled at the wrist housing. The tilt is rotatable relative to the wrist housing about an axis of rotation and includes a drive unit including a motor with a motor housing. A shell part of the motor housing is designed to connect the tilt to the wrist housing.

### TECHNICAL FIELD

The present invention relates to a robot wrist for an industrial robot, said robot wrist comprising a wrist part, here referred to as a tilt, journalled at a wrist housing. The tilt is rotatable relative to the wrist housing about an axis of rotation and comprises a drive unit including a motor with a motor housing. The invention also relates to an industrial robot and a tilt for a robot wrist.

### BACKGROUND ART

An industrial robot is composed of interconnected robot parts. Two adjacent robot parts may be interconnected so that they are either rotatable or turnable in relation to each other about an axis of rotation or are linearly displaceable in relation to each other. An industrial robot often comprises a tilt supporting a toolholder. The tilt is connected to an arm of the robot in a so-called robot wrist. The toolholder usually consists of a rotatable holder on which tool may be attached. The industrial robot is adapted to displace and rotate the robot parts in such a way that the toolholder and hence a tool connected to the toolholder are moved according to a predetermined pattern between different operating stations.

A robot wrist and a tilt of the type mentioned above are described, for example, in Swedish patent 508 817. This tilt comprises a motor, such as electric motor, adapted to drive the rotating movement of the toolholder such that the tool may be rotated between different positions. The tilt is rotatably connected to a wrist housing in a robot wrist via a so-called fork. The fork comprises a body formed as a sleeve into which the tilt is inserted. Further, the fork comprises two flanges projecting from opposite sides of the body and adapted to rotatably fix the fork to the wrist housing. The wrist housing comprises two branches projecting from one end of the wrist housing, the tilt being provided between the branches in such a way that the two flanges of the fork are each rotatably journalled in a respective branch. With the aid of a motor located in the robot arm or the wrist housing, the fork and hence the tilt including its motor and toolholder may be rotated relative to the wrist housing about an axis of rotation between different positions.

One problem with the above known design is that when the robot is to be dimensioned for very high handling weights, such as for handling weights in excess of 100 kg, the tilt and the robot wrist may become very large and heavy. To handle handling weights as heavy as in excess of 100 kg, the motor in the tilt must be made powerful, which also means that the motor will be large and heavy. Consequently, also the fork and the robot wrist must be made large. There is then a risk that the tilt and the robot wrist together become so large that difficulties may arise in inserting the tilt through narrow openings. For example, difficulties may arise for robots designed for very high handling weights in reaching spaces, for example, inside car windows when welding car bodies.

The term handling weight, in this description and the accompanying claims, means the weight supported by the tilt. The maximum handling weight thus constitutes the maximum weight that the tilt is designed to support.

Swedish patent 465 611 describes a robot wrist and a tilt which are designed to achieve a reduction of the size of the robot wrist and the tilt. This tilt comprises a motor arranged inside a casing, said motor being adapted to rotate a toolholder. The motor is provided with two projecting flanges which are each intended to be rotatably connected to a respective one of two projecting branches of a wrist housing. The fork here consists of the two flanges and an intermediate element adapted to connect the flanges to each other. The intermediate element also constitutes the front of the casing of the motor. By fixing the flanges directly to the casing of the motor, the size of the fork may be reduced compared with designs of the type shown in SE 508 817, whereby also the size of the tilt and the robot wrist may be reduced. Also for this design of the robot wrist, the tilt and the robot wrist may become too large when being designed for high handling weights.

### SUMMARY OF THE INVENTION

The object of the present invention is to provide a robot wrist which enables a reduced size and a reduced weight of the robot wrist in relation to a corresponding robot wrist according to the prior art when designing the robot for a certain handling weight.

According to the invention, this object is achieved by means of a device that exhibits the features described in claim 1. By connecting the shell part of the motor housing directly to the wrist housing, neither a fork nor any flanges are needed for attaching the tilt to the wrist housing. This will make it possible to reduce the size of the robot wrist, thus also reducing the weight of the robot wrist, compared with a corresponding robot wrist according to the prior art when dimensioning for a certain handling weight. Further, it will be possible to reduce the cost of the manufacture of the robot wrist since the fork is omitted from the robot wrist. With the omission of the fork, one stage in the production also disappears, which makes it possible to shorten the production time and reduce the production costs further. According to the invention, the motor housing will serve both as a means to rotatably connect the tilt to the robot arm, that is, it will exhibit a function corresponding to that of the previously mentioned fork, and to protect the motor against external influence. Further, an improved heat transport from the tilt is made possible in that heat is effectively transported from the shell part to the wrist housing and further to a connecting robot arm, whereby heat from the tilt motor is also discharged via the wrist housing and the robot arm. This makes the motor useful for a higher power without the motor being overheated.

The shell part of the motor housing, as used in this description and the appended claims, means a part of the outer wall of the motor housing.

According to a preferred embodiment of the invention, the inside of the shell part comprises a shoulder, whereby the stator makes contact with the shoulder to prevent displacement of the stator in an axial direction relative to the motor housing. This keeps the stator in position inside the motor housing in a simple and functional manner.

According to another preferred embodiment of the invention, the motor housing comprises an opening adapted to allow insertion of the stator into the motor housing, whereby the motor housing comprises a sealing member adapted to seal the opening. This makes it possible to manufacture the tilt in a simple manner when the motor housing has an opening through which the stator may be inserted into the motor housing. This design also makes it possible, in a simple manner, to reach the motor parts arranged inside the motor housing for repair and/or replacement thereof.

According to a yet another preferred embodiment of the invention, the sealing member comprises a front portion adapted to be received inside the shell part. This makes it possible, in a simple manner, to attach the sealing member to the opening of the motor housing by inserting said front portion into the shell part.

According to still another preferred embodiment of the invention, the stator is clamped between the front portion of the sealing member and the shoulder of the shell part. When the sealing member is applied to the opening, the front portion of the sealing member is pressed against the stator, whereby the stator is also pressed against the shoulder. The stator will thus be clamped between the front portion of the sealing member and the shoulder. This keeps the stator in position inside the motor housing in a very simple and cost-effective way.

According to a further preferred embodiment of the invention, the shell part is provided on its outside with at least one fixing member, whereby the fixing member is rigidly connected to a corresponding fixing member of the wrist housing, wherein the fixing member of the shell part comprises a recess and the fixing member of the wrist housing comprises a shaft journal received in said recess, or vice versa. This brings about a reliable connection between the two fixing members. Further, the shaft journal is an efficient structure for transmitting to the tilt a rotary motion generated by, for example, a motor located in the wrist housing or the robot arm.

According to a still further preferred embodiment of the invention, a fixing member of the shell part and a corresponding fixing member of the wrist housing make contact with each other via mutual contact surfaces, whereby these contact surfaces are provided with countersunk and/or raised portions adapted to engage with each other to convey a rotary force between the fixing members. For example, the two fixing members are provided with grooves that engage with one another, whereby the risk of slipping between the fixing members is reduced. This makes it possible to transmit a rotary force between the wrist housing and the tilt in a reliable and efficient manner. Further, this makes possible a reduction of the number of fixing elements, for example screws, which hold the cooperating fixing members together.

According to yet a further preferred embodiment of the invention, the shell part comprises two fixing members on essentially opposite sides of the shell part. The rotary force is advantageously transmitted through the connection of one of the fixing members to the wrist housing, whereby, for example, cabling is led between the tilt and the wrist housing through the connection of the other fixing member to the wrist housing. By connecting the tilt to the wrist housing in two connections, the tilt will be stronger than if only one connection to the wrist housing were used.

According to an additional preferred embodiment of the invention, the robot wrist is designed for a maximum handling weight of at least 100 kg. The invention is especially suited for industrial robots which are designed for large handling weights, such as 100 kg or more, since such robots require strong and hence large tilts and robot wrists. Previously within this technical field, it was considered quite necessary to have a fork between the tilt and the robot arm to handle these weights.

The invention also relates to an industrial robot according to claim 18 and a tilt according to claim 19.

The drive unit arranged in the tilt is suitably adapted to bring about a rotation of a second part of the tilt in relation to a first part thereof. However, it is also within the scope of the invention for the drive unit arranged in the tilt to be designed to bring about a rotation of the tilt itself in relation to the wrist housing. It is also within the scope of the invention for the drive unit of the tilt to comprise a first motor for rotating the tilt around a first axis of rotation and a second motor for rotating a second part of the tilt in relation to a first part of the tilt around a second axis of rotation. The design of the robot wrist and the tilt may otherwise be adapted in dependence on the application of the industrial robot.

### BRIEF DESCRIPTION OF THE DRAWINGS

The invention will now be described in greater detail, by means of embodiments, with reference to the accompanying drawings, wherein:

FIG. 1 shows an example of an industrial robot.

FIG. 2 shows a robot wrist and a tilt according to one embodiment of the invention.

### DESCRIPTION OF THE PREFERRED EMBODIMENTS

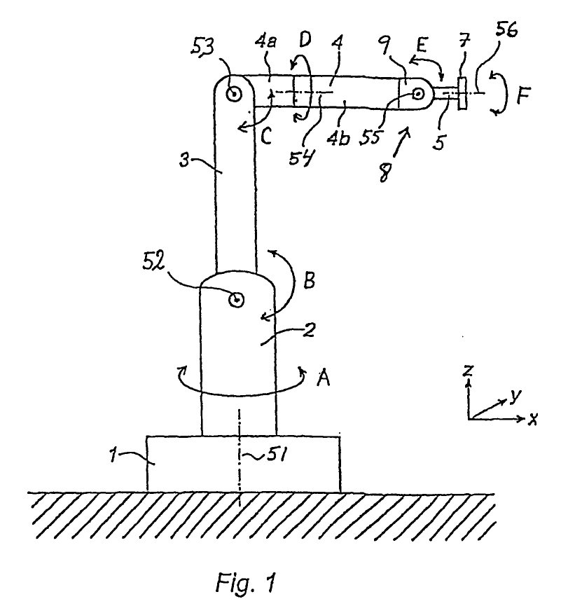

FIG. 1 shows an example of an industrial robot comprising a robot wrist 8. The robot comprises a foot 1, which is mounted against a base. The robot further comprises a stand 2, which is rotatable in relation to the foot 1 about a first axis 51. The rotary motion of the stand about this first axis 51 is indicated in FIG. 1 by the arrow A. At the end of the stand, a first robot arm 3 is rotatably journalled in relation to the stand about a second axis 52. The rotary motion of the first robot arm about this second axis 52 is indicated in FIG. 1 by the arrow B. The industrial robot shown further comprises a second robot arm 4, which is rotatably journalled at the outer end of the first robot arm about a third axis 53. The rotary motion of the second robot arm about this third axis 53 is indicated in FIG. 1 by the arrow C. The second robot arm 4 comprises two parts, one inner part 4a and one outer part 4b, the outer part 4b being rotatable in relation to the inner part 4a about a fourth axis 54, which coincides with the longitudinal axis of the second robot arm 4. The rotary motion of the outer part about this fourth axis 54 is indicated in FIG. 1 by the arrow D. The robot wrist 8 is arranged at the outer end of the robot arm 4 and comprises a wrist housing 9 that is supported by the outer part 4b of the second robot arm. The robot wrist 8 further comprises a wrist part 5, here designated tilt, journalled in the wrist housing 9.

The wrist housing 9 advantageously constitutes a structural part that is separate from the robot arm 4 and is suitably detachable from the robot arm 4 such that the robot wrist 8 may be detached from the robot arm 4 for repair or replacement. In this case, the wrist housing 9 is attached to the robot arm with the aid of suitable fixing elements, such as screws, bolts or the like. According to an alternative embodiment of the invention, the wrist housing 9 constitutes an integral part of the robot arm 4.

The tilt 5 is rotatably journalled at the wrist housing 9 and is rotatable in relation to the wrist housing 9 about a fifth axis 55. The rotary motion of the tilt about this fifth axis 55 is indicated by the arrow E in FIG. 1.

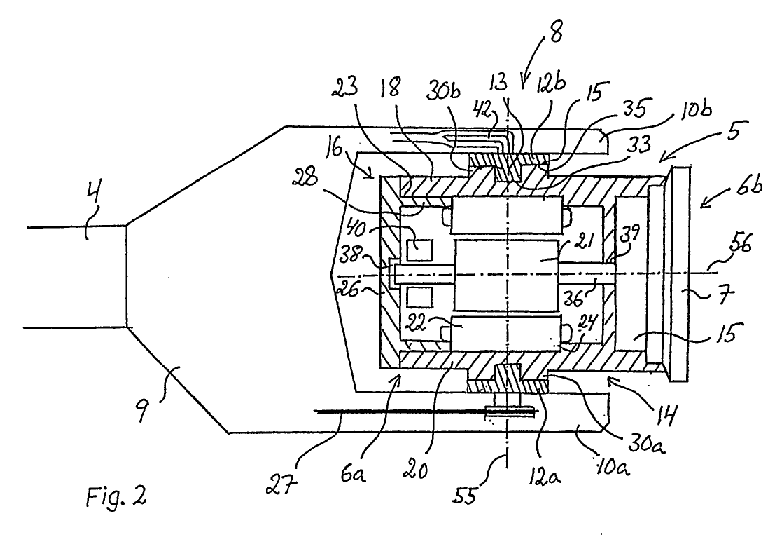

According to a preferred embodiment of the invention, which is illustrated in FIG. 2, the tilt comprises a first part 6a and a second part 6b connected to the first part. The first part 6a is rotatably journalled at the wrist housing 9 and is tiltable about a fifth axis 55. The second part 6b of the tilt is adapted to support a toolholder 7 or the like and is rotatable relative to the first part 6a about a sixth axis 56. The rotary motion of the second part 6b about this sixth axis 56 is indicated in FIG. 1 by the arrow F. By rotating the first part 6a of the tilt about the axis of rotation 55, a rotation of the entire tilt 5 relative to the wrist housing 9, and hence relative to the robot arm 4, is achieved about this axis of rotation 55. By rotating the second part 6b of the tilt about the axis of rotation 56, a rotation of the toolholder 7 is achieved both relative to the first part 6a of the tilt and relative to the wrist housing 9. The axis of rotation 56 is preferably perpendicular to the axis of rotation 55. Further, the second part 6b of the tilt is suitably arranged so that this part, and hence also the toolholder 7, is rotatable in one or more full revolutions around the axis of rotation 56.

The wrist housing 9, at which the tilt 5 is journalled, comprises, in the embodiment shown in FIG. 2, two branches 10a and 10b projecting from the outer end of the wrist housing. These branches 10a, 10b are arranged to project in the longitudinal direction of the wrist housing 9 and the robot arm 4 and exhibit between them a space for receiving the tilt 5. The wrist housing 9 further comprises two fixing members 12a, 12b arranged in each of the projecting branches 10a, 10b. These fixing members 12a, 12b are rotatably journalled at the wrist housing 9. The tilt 5, which is shown in cross section in FIG. 2, is rotatably connected to the wrist housing 9 via the fixing members 12a, 12b of the wrist housing so that the tilt is rotatable about the axis of rotation 55 relative to the wrist housing 9. The first 6a part of the tilt 5 is thus arranged essentially between the branches 10a, 10b. The tilt 5 comprises a drive unit 14 for rotating the second part 6b of the tilt relative to the first part 6a about the axis of rotation 56. This drive unit 14 comprises a motor 16 comprising a motor housing 18. The drive unit 14 is arranged to drive the rotation of the toolholder 7.

According to the present invention, the motor housing comprises a shell part 20 which is designed to connect the tilt 5 to the wrist housing 9. The motor housing 18 is arranged to constitute an outer wall in the first part 6a of the tilt 5. In this example, the shell part 20 is designed to rotatably connect the tilt 5, or more specifically the first part 6a of the tilt, to the wrist housing 9 in such a way that the shell part 20 is connected to the rotatable fixing members 12a, 12b. This saves space in the robot wrist since the tilt 5 need not be connected to the wrist housing 9 by means of an intermediate fork. The motor housing 18 thus functions both as protection for the drive components of the motor 16 and as element for connecting the tilt 5 to the wrist housing 9. In this example, the motor housing 18 and hence also the shell part 20 and the first part 6a of the tilt are essentially cylindrical, but it is also possible to allow the motor housing 18 to be essentially rectangular or to exhibit any other suitable shape.

The motor 16 is preferably an electric motor, adapted to generate a force for driving the rotation of the toolholder 7. To this end, the motor 16 comprises a rotor 21 and a stator 22. FIG. 2 shows the stator 22 in a cross section. The stator 22 is essentially cylindrical, whereby the stator 22 is arranged along the inside of the shell part 20. The shell part 20 is thus arranged to surround the stator 22. Further, the stator 22 makes contact with the inside of the shell part 20. This causes the distance between the stator 22, which constitutes the radially outermost drive component of the motor, and the shell part 20, which constitutes the radially outermost component of the motor housing 18, to be as small as possible, which reduces the size of the motor 18 and hence of the tilt 5 and the robot wrist in a direction across the longitudinal axis of the tilt 5. Further, the motor housing 18 makes contact directly with the fixing members 12a, 12b via the shell part 20. In this way there will be no unnecessary air gaps between the connection between the tilt 5 and the wrist housing 9 and the radially outermost drive component of the motor 16, i.e. the stator 22, which further contributes to reduce the size of the robot wrist in a direction across the longitudinal axis of the tilt 5. Further, the stator 22 has an essentially cylindrical cavity in the centre of and straight through the stator 22 in the axial direction of the stator. The cavity is arranged to receive the rotor 21, whereby the rotor 21 is thus arranged inside the stator 22.

The shell part 20 further comprises a shoulder 24 designed to project from and extend around the cylindrical inside of the shell part 20. The stator 22 is designed to make contact with the shoulder 24. The stator 22 makes contact with the shoulder 24 with one of its radially extending sides. The shoulder 24 thus prevents the stator 22 from being displaced in an axially forward direction, that is, in a direction towards the toolholder 7.

The motor housing 18 further comprises an opening 23 designed to allow insertion of the stator 22 and the rotor 21 into the motor housing 18 when manufacturing the tilt 5. In the illustrated embodiment, the opening 23 is arranged in the rear part of the tilt. Further, the motor housing 18 comprises a sealing member 26 designed to seal the opening 23. The sealing member 26 comprises a front portion 28 designed to be inserted into the opening 23 and to be received inside the shell part 20. This front portion suitably has an outer diameter that essentially corresponds to, or is only slightly smaller than, the inner diameter of the rear portion of the shell part. The front portion 28 is designed to be pressed against the rear radially extending side of the stator 22 when the sealing member 26 is applied in the opening. The front portion 28 thus presses the stator 22 against the shoulder 24. The stator 22 is thus clamped between the front portion 28 of the sealing member 26 and the shoulder 24 when the sealing member seals the opening 23. The sealing member 26 is suitably fixed to the shell part 20 with the aid of suitable fixing elements, such as screws or the like.

The shell part 20 is provided with fixing members 30a, 30b arranged on the outside of the shell part 20. These fixing members 30a, 30b are suitably formed direct in the shell part 20 so that they constitute an integral part thereof. The fixing members 30a, 30b are designed to connect the shell part 20 and hence the tilt 5 to the rotatable fixing members 12a, 12b of the wrist housing 9. The fixing members 30a, 30b are rigidly connected to the rotatable fixing members 12a, 12b, the tilt 5 thus being rotatable about the axis of rotation 55 of the fixing members 12a, 12b by rotating the fixing members 12a, 12b. In the illustrated embodiment, the axis of rotation 55 is essentially perpendicular to the longitudinal direction of the wrist housing 9 and the robot arm 4. The wrist housing 9 further comprises means for controllably rotating at least one of the fixing members 12a, 12b in a manner well known within this technical field. In the embodiment shown in FIG. 2, this means comprises a drive belt 27, which is connected to the fixing member 12a and which is driven by a motor (not shown) arranged in the wrist housing 9 or the robot arm 4. Thus, the tilt 5 is rotatable, or tiltable, about the axis of rotation 55 in a controllable manner.

The fixing members 30a, 30b are each designed to fit a respective one of the fixing members 12a, 12b. In the illustrated embodiment, the outside of the shell part 20 is designed to constitute the fixing members 30a, 30b. The fixing members 12a, 12b of the wrist housing 9 are thus connected to the tilt 5 directly onto the outside of the shell part 20. The fixing members 30a, 30b on the outside of the shell part 20 each comprises a surface 35 that extends essentially perpendicular to the axis of rotation 55. This surface 35, which is suitably essentially circular, is designed to make contact with a corresponding, essentially circular, surface 15 of one of the fixing members 12a, 12b of the wrist housing 9. Thus, also the respective surface 15 of the fixing members 12a, 12b of the wrist housing 9 extends essentially perpendicular to the axis of rotation 55. Said confronting surfaces 15, 35 of the fixing members 30a, 30b, 12a, 12b are further secured to each other by means of fixing elements, for example by means of screws. Further, the respective surface 35 of the fixing members 30a, 30b of the shell part 20 comprises a recess 33 adapted to receive a shaft journal 13 of the fixing members 12a, 12b of the wrist housing. This ensures a reliable connection between the fixing members 30a, 30b of the shell part 20 and the fixing members 12a, 12b of the wrist housing 9.

Further, said surfaces 35 of the fixing members 30a, 30b of the shell part 20 comprise countersunk portions and raised portions, preferably in the form of grooves, which are designed to engage with corresponding countersunk and raised portions in the corresponding surfaces 15 of the fixing members 12a, 12b of the wrist housing 9. The grooves are designed to convey a torque between the pairs of fixing members 12a, 30a, 12b, 30b. A rotation of one fixing member 12a, 12b is thus effectively transmitted to its corresponding fixing member 30a, 30b by the grooves engaging with each other. This makes it possible to reduce the number of fixing elements, for example the number of screws, designed to firmly connect the fixing members 12a, 30a, 12b, 30b to one another.

One pair of fixing members 12b, 30b in the illustrated embodiment is primarily designed to support the tilt 5 and not to transmit any torque. Further, this pair of fixing members 12b, 30b is suitably designed to facilitate passage of cables for electricity and/or control signals from the wrist housing 9 to the tilt 5. FIG. 2 schematically shows a cable bundle 42 in the second projecting branch 10b that passes from the wrist housing 9 to the tilt 5 through a passageway arranged in said pair of fixing members 12b, 30b in a manner well known within this technical field. In an alternative embodiment of the invention, the force from the motor in the wrist housing 9 is transmitted to the tilt 5 for rotating the tilt 5 with the aid of both pairs of fixing members 12a, 30a, 12b, 30b. Further, it is possible to design the fixing members 12a, 12b, 30a, 30b in a manner different from that shown here, for example with some form of gear mechanism for transmitting torque in a pair of fixing members.

The stator 22 of the motor 16 in the illustrated embodiment comprises a laminated stator core and a stator winding. The stator winding is designed to generate a magnetic field when an electric current is applied to flow through the winding. The laminated stator core comprises a plurality of stator laminations, placed in parallel, with electrical insulation inserted between the laminations. The stator laminations are designed to reinforce the magnetic field that is generated when current flows through the stator winding. The electrical insulation is designed to reduce the eddy currents that may arise in the stator laminations. The laminated stator core is further arranged in direct contact with the inside of the shell part 20.

The rotor 21 of the motor 16 comprises a number of permanent magnets and a rotor shaft 36. When said magnetic field is generated by the stator 22 in that region of the motor 16 where the rotor 21 is situated, an electromagnetic force is generated which acts on the permanent magnets. The force on the permanent magnets causes the rotor 21 and the rotor shaft 36 to rotate. To facilitate the rotation of the rotor shaft 36, the rotor shaft 36 is rotatably journalled in a bearing 38 in the motor housing 18. In the embodiment shown in FIG. 2, this bearing 38 is arranged in the sealing member 26. Further, the drive unit 14 suitably comprises a brake device 40 designed to brake the rotation of the rotor shaft 36 when necessary.

Further, the drive unit 14 comprises a gear 15, the rotor shaft 36 being connected to the gear 15. The gear 15 is designed to transmit the rotating movement of the rotor shaft 36 to the toolholder 7. Between the gear 15 and the motor 16, the motor housing 18 comprises an additional bearing 39 for the rotor shaft 36. The gear 15 achieves a reduction of the speed of the rotor shaft 36 when transmitting the rotational movement to the toolholder 7, whereby the gear 15 also transforms the torque of the rotor shaft 36 to a higher torque. According to a preferred embodiment, the gear 15 is designed to change the rotational movement in such a way that 100 rotor shaft turns correspond to one turn of the toolholder 7. In alternative embodiments, the gear has a gear reduction of between 80 and 200. The motor housing 18 is designed to constitute a seat for the gear 15, whereby the motor housing 18 also supports the gear 15.

The rotation of the rotor 21 is thus transmitted to the toolholder 7 via the gear 15, the toolholder 7 being rotatable about the axis of rotation 56. In the illustrated embodiment, the axis of rotation 56 is essentially parallel and coinciding with the longitudinal direction of the tilt 5 and essentially perpendicular to the axis of rotation 55. Thus, the drive unit 14 is designed to rotate the toolholder 7 about the axis of rotation 56. The toolholder 7 is adapted for attachment of a tool to the toolholder 7, the tool being rotatable between different positions by means of the drive unit 14. In the illustrated embodiment, the toolholder 7 is a turn disc.

In an alternative embodiment of a robot wrist according to the invention, the tilt is only connected to the wrist housing at one connection point, whereby the tilt, for example, is journalled in one single branch projecting from the wrist housing. This makes it possible to further reduce the size the robot wrist.

In the embodiment of the invention illustrated in FIG. 2, the drive unit 14 arranged in the tilt 5 is adapted to bring about a rotation of a second part 6b of the tilt in relation to a first part 6a thereof, as described above. However, it is also within the scope of the invention to arrange the drive unit mounted in the tilt to achieve a rotation of the tilt itself in relation to the wrist housing, that is, a rotation of the tilt 5 about the axis of rotation 55. According to the latter embodiment, the motor of the drive unit is, for example, arranged in the tilt 5 in the manner shown in FIG. 2, that is, with its axial direction perpendicular to the axis of rotation 55, whereby a rotary force is transmitted from the output shaft of the motor to a rotatable fixing member of the tilt via a suitable gear arrangement. It is also within the scope of the invention for the drive unit of the tilt to comprise a first motor for rotating the tilt about the axis of rotation 55 and a second motor for rotating a second part of the tilt in relation to a first part of the tilt about the axis of rotation 56.

Also in other respects, the embodiment shown should only be seen as a non-limiting example of the invention, which may be varied freely within the scope of the appended claims.

For example, the shape of the tilt may be adjusted in dependence on the application of the industrial robot. Any fixing member according to known or future technique may be used in connection with the invention. Further, it is possible to allow the fixing members of the tilt to be rotatably journalled relative to the motor housing whereas the fixing members of the wrist housing are fixed relative to the wrist housing. The motor in the tilt may be a motor based on a chemical reaction instead of being based on electricity. The gear ratio of the gear may be changed, or the gear may be omitted completely. Likewise, it is possible to omit the toolholder, whereby the motor in the tilt directly drives a tool, such as a drill. Further, the industrial robot according to the invention may, of course, be provided with a larger as well as a smaller number of cooperating robot arms than what is shown in FIG. 1 and also in other respects have a design different from that shown in the figures.

1. A robot wrist for an industrial robot, said robot wrist comprising a wrist housing and a wrist part, here designated tilt, journalled at the wrist housing, wherein the tilt is rotatable relative to the wrist housing about an axis of rotation and comprises a drive unit comprising a motor with a motor housing, wherein a shell part of the motor housing is designed to connect the tilt to the wrist housing.

2. The robot wrist according to claim 1, wherein the tilt comprises a first part that is rotatable relative to the wrist housing about a first axis of rotation, and a second part that is connected to the first part and designed to support a toolholder or the like and that is rotatable relative to the first part about a second axis of rotation.

3. The robot wrist according to claim 2, wherein the drive unit is arranged for rotation of the second part relative to the first part about the second axis of rotation.

4. The robot wrist according to claim 1, wherein the drive unit is arranged for rotation of the tilt relative to the wrist housing.

5. The robot wrist according to claim 1, wherein the outside of the shell part is designed to connect the tilt to the wrist housing.

6. The robot wrist according to claim 1, wherein the motor comprises a stator and a rotor arranged in the motor housing, the shell part being adapted to surround the stator.

7. The robot wrist according to claim 6, wherein the stator makes contact with the shell part.

8. The robot wrist according to claim 7, wherein the stator makes contact with the inside of the shell part.

9. The robot wrist according to claim 8, wherein the inside of the shell part comprises a shoulder, wherein the stator makes contact with the shoulder to prevent displacement of the stator in an axial direction relative to the motor housing.

10. The robot wrist according to claim 6, wherein the motor housing comprises an opening adapted to allow insertion of the stator into the motor housing, wherein the motor housing comprises a sealing member adapted to seal the opening.

11. The robot wrist according to claim 10, wherein the sealing member comprises a front portion adapted to be received inside the shell part.

12. The robot wrist according to claim 9, wherein the stator is clamped between the front portion of the sealing member and the shoulder of the shell part.

13. The robot wrist according to claim 1, wherein the shell part is provided on its outside with at least one fixing member, which is rigidly connected to a corresponding fixing member in the wrist housing.

14. The robot wrist according to claim 13, wherein the fixing member of the shell part comprises a recess and wherein the fixing member of the wrist housing comprises a shaft journal received in said recess, or vice versa.

15. The robot wrist according to claim 13, wherein a fixing member of the shell part and a corresponding fixing member of the wrist housing make contact with each other via mutual contact surfaces, whereby these contact surfaces are provided with countersunk and/or raised portions adapted to engage with each other to transmit a rotary force between the fixing members.

16. The robot wrist according to claim 13, wherein the shell part is provided with two fixing members on essentially opposite sides of the shell part.

17. The robot wrist according to claim 1, wherein the robot wrist is designed for a maximum handling weight of at least 100 kg.

18. An industrial robot, wherein the industrial robot comprises a robot wrist according to claim 1.

19. A tilt intended to be journalled in a wrist housing of a robot wrist for an industrial robot, wherein the tilt is rotatable relative to the wrist housing about an axis of rotation and comprises a drive unit comprising a motor with a motor housing, wherein a shell part of the motor housing is designed to connect the tilt to the wrist housing.

20. The tilt according to claim 19, wherein the tilt comprises a first part that is rotatable relative to the wrist housing about a first axis of rotation, and a second part that is connected to the first part and is designed to support a toolholder or the like and that is rotatable relative to the first part about a second axis of rotation.

21. The tilt according to claim 20, wherein the drive unit is adapted for rotation of the second part relative to the first part about the second axis of rotation.

22. The tilt according to claim 19, wherein the drive unit is adapted for rotation of the tilt relative to the wrist housing.
